(19) United States
(12) Patent Application Publication
(10) Pub. No.: US 2008/0113330 A1
(43) Pub. Date: May 15, 2008

(54) Method for the Combined Education of Adolescent Parents and Children

(76) Inventor: Aminyah Muhammad-M'Backe, Washington, DC (US)

Correspondence Address: SUTHERLAND ASBILL & BRENNAN LLP, 999 PEACHTREE STREET, N.E., ATLANTA, GA, 30309, US

(21) Appl. No.: 11/939,229

(22) Filed: Nov. 13, 2007

Related U.S. Application Data
(60) Provisional application No. 60/865,317, filed on Nov. 10, 2006.

(51) Int. Cl. G09B 19/00

(52) U.S. Cl. 434/433

(57) ABSTRACT

The present invention is directed towards educating adolescent parents and their young children. The education methodology includes one curricular component that is directed specifically toward educating adolescent parents, one curricular component that is directed specifically toward educating young children of adolescent parents. The education methodology may also include a curricular component that is directed toward educating adolescent parents about parenting and life skills. The education methodology may also include a curricular component that is directed toward fostering parent and child interaction and teaching by adolescent parents to their young children. Finally, the education methodology may be at least partially implemented residential facility that allows adolescent parents and their young children to live together.

### RELATED APPLICATION CROSS-REFERENCE

This application claims the benefit of prior-filed U.S. Provisional Patent Application Ser. No. 60/865,317, filed on Nov. 10, 2006, which is incorporated by reference in its entirety as if fully set forth herein.

### FIELD OF THE INVENTION

This invention relates generally to the field of education, and more particularly to education methodologies that include curricula directed toward adolescent parents, young children, and integrated teaching of young children by their adolescent parents.

### BACKGROUND OF THE INVENTION

Education is fundamental in shaping children and young adults and preparing them for their future. It is, however, becoming increasingly apparent that educational curricula needs to be widely adaptable for the diverse needs of the students. Students not only come from different backgrounds or have different learning styles, they also require curricula that instruct and prepare them for different life experiences.

Traditionally, a formal public education system includes three general levels of education: elementary, secondary, and post-secondary. Students typically spend six to eight years in the elementary level and frequently one to three years in pre-elementary programs like pre-school, nursery school, or kindergarten. Depending upon the educational design of the school system, students then typically spend four to six years in secondary education. Post-secondary is most frequently elective and not mandated by the governing laws. While the average size of the elementary school student population seems to remain relatively constant over the last ten years, the size of secondary school populations is increasing.

Recent studies show that adults who attain higher levels of education are more likely to participate in the labor force. For example, statistical research by the United States Department of Education shows that among persons twenty-five years or older, approximately seventy-eight percent of those who have attained at least a bachelor's degree participate in the labor force, while approximately sixty-three of those achieving only a high school education participate and only approximately forty-five percent of those who had not completed high school participate. (United States Department of Education: Institute of Education Sciences, “Digest of Education Statistics: 2005,” Chapter 1, FIG. 1).

Because of the varied experiences for which secondary education prepares students, and because of the diverse backgrounds and life situations of the student population, there exists an opportunity for a curriculum that can be adapted to address a particular subset of student population. Adolescent parents and their children present a particularly difficult student population to educate and to prepare for their future. Adolescent parents have the increased difficulty of obtaining an appropriate education, like that taught in typical secondary school curricula, while at the same time balancing parental and familial responsibilities. The increased responsibilities of economically and emotionally providing for their children tends to further hinder adolescent parents' abilities to focus on a typical secondary education curriculum. Studies have shown that in some areas of the United States a majority of female-headed households live below the poverty line, and a substantial percentage of those women have dropped out of high school, listing pregnancy as the single most frequent reason for dropping out.

Often times, the difficulties suffered by adolescent parents are systemic, frequently having been raised by adolescent parents themselves, thus creating a void in the amount and type of educational and life resources readily available to them outside of their education system. For example, adolescent parents have described themselves using adjectives such as scared, isolated, overwhelmed, challenged, and confused. Service providers working with adolescent parents describe them as suffering from an arrest of emotional growth, detached, behaviorally challenged—sometimes acting as adults and sometimes acting as children, lacking aspiration, and emotionally unprepared to act as parents.

The educational success of adolescent parents might be predicted by factors such as the number of schools attended, home environments, and peer group influences. Excessive mobility between schools disrupts social and academic learning. Studies show, however, that family background has a profound affect on the students' own expectations of academic achievement. Additionally, studies are showing that many at-risk students in inner-city school systems are pressuring or being pressured by their peers to engage in antisocial activities at the cost of academic learning.

High risk youths, or those with complex life experiences, need educational and social learning experiences that are innovative, active, and collaborative. The more contribution the students make to the curriculum and their learning experiences, the more likely they are to feel in control. Engendering in the students a feeling of control and partial ownership over their curriculum encourages active participation and increases the effectiveness of teaching.

Just as adolescent parents frequently suffer from their parents being adolescent, their children are at risk to suffer the same fate. Young children of adolescent parents are often isolated from extended family members, dependent upon the depressed and angry parent to care for them in ways that are often inappropriate, unsafe, and unhealthy. Many of these children have special needs because their mothers lacked proper medical care during pregnancy. Mothers taking drugs and drinking during their pregnancies result in their children suffering from FAS, Fetal Alcohol Syndrome. Even if the mental conditions are not as severe as FAS, these children may have the potential to suffer depression at very young ages. Young children having such experiences will need specialized pre-elementary experiences in a setting that offers quality early childhood education as well as other early learning experiences and emotional and psychological assistance.

Thus, there exists a need for a set of curricula that specifically addresses the unique needs of adolescent parents and their young children that will foster both learning and development.

### SUMMARY OF THE INVENTION

The present invention is directed toward educating adolescent parents and their young children in a manner that addresses the unique educational needs of adolescent parents and their children and that considers their family circumstances and unique learning preferences. The education methodology may include one curricular component that is directed specifically toward educating adolescent parents in place of a typical public school education curriculum. This may include a curriculum that is at least partially adaptable to the adolescent parents' wishes and interests. Also, the education methodology may include a curricular component that is directed specifically toward educating young children of adolescent parents, providing effective early childhood education considering their unique emotional and psychological circumstances. The education methodology may also include a curricular component that is directed toward educating adolescent parents about parenting and life skills. The education methodology may also include a curricular component that is directed toward fostering parent and child interaction and teaching by adolescent parents to their young children. Finally, the education methodology may be implemented in a school environment that allows adolescent parents and their young children to live together in monitored, instructional housing, fostering the social and family interaction between peer groups and between parents and children.

In one example embodiment of the present invention, the method of educating includes instructing multiple adolescent parents, instructing at least one young child of each of the adolescent parents, wherein at least a portion of the instruction is given by the adolescent parents, and residing in at least one residential facility by the adolescent parents and their young children. The instruction given is specifically adapted to the needs of the plurality of adolescent parents, which teaches parenting skills and life skills.

The method of educating may optionally include progressive learning techniques. The method may also include assessing the performance of the adolescent parents by an accepted performance standard. The adolescent parents may be between fourteen and twenty-one years of age.

The residential facility of the method may include a plurality of private residence spaces, and may optionally include at least one communal space. A method that includes a communal space may include a kitchen the communal space. The instructing of the method may take place at least partially in the residential facilities.

According to another example embodiment of the present invention, the method of educating includes instructing multiple adolescent parents by at least one instructor, instructing at least one young child of each of the adolescent parents by the instructor or instructors, instructing the young child or children by the adolescent parents, and residing in at least one residential facility by the adolescent parents and the young child or children of each of the adolescent parents. The adolescent parents may instruct their own children, according to this example embodiment. The instructor or instructors may reside at the residential facility as well, in this example embodiment.

### BRIEF DESCRIPTION OF THE DRAWINGS

FIG. 1A provides a graphical system diagram according to one embodiment of the invention.

FIG. 1B provides an example schedule according to one embodiment of the present invention.

FIG. 1C provides an example schedule according to one embodiment of the present invention.

FIG. 2 provides a graphical system diagram according to another embodiment of the invention.

### DETAILED DESCRIPTION OF THE INVENTION

The subject matter described herein is directed toward a unique combination of curricular components, teaching methodologies, standards, and goals that, when taken as a whole, create a unique teaching methodology. The teaching methodology includes unique perspectives and approaches on in-class and out-of-class teachings. More particularly, this teaching methodology, in one example embodiment, is directed towards educating adolescent parents and their young children, in a multi-faceted curriculum addressing the educational needs of the adolescent parents and the young children, as well as the real-life situations in which these families live. The curriculum may be specifically tailored towards the special needs of these adolescent parents and young children that collectively comprise the student body participants of the education methodology described herein.

The purpose of this unique education methodology is to develop and support Healthy Families, by creating a healthy community where adolescent parents can become effective parents and productive adults, so that they can, overtime, provide a better home and living environment, and perhaps break a family cycle of poverty and under-education.

The education methodology described herein is based on a developmental strengths and assets model. These adolescent parents participating in the education methodology have the courage and capacity to bounce back into productive lives. In a developmental approach, it is not possible to order learning in a sequence because no matter how well researched such ordering might be, it cannot account for the uniqueness of each student's pattern of interests and strengths. Therefore, to support their growth, this education methodology aims to provide: education that is purposeful and transparent, based on cognitive science; instruction that is contextualized; a teaching and learning cycle that includes goal setting, student-centered instruction and on-going informal and formal assessment; and data collection to be used for continuous improvement.

The methods described herein can be described as “progressive” methods, as is known in the art of educational curriculum design. “Progressivism” places a premium on individual development. Learning, therefore, is approached holistically and includes paying attention to the students' emotional, spiritual, physical, social, and intellectual needs. Classroom activities may be student-centered, hands-on, project-based, and cooperative in nature. Students may, in some embodiments, assume ownership of tasks and accountability for their learning. Furthermore, they may be encouraged to work without instructor intervention or without constant supervision. In some embodiments of practicing this education methodology, the instructor may relinquish her role as an expert or a provider of knowledge, and assume the role of a facilitator or a resource person.

Objectives of the methods described herein include providing a healthy family-focused atmosphere, a safe environment, and an opportunity for adolescent parents to increase their literacy and other educational skills, and their parental abilities, while also improving the educational opportunities of their young children. One objective met by these methods is to assist adolescent parents in meeting accepted standards in reading, writing, English language acquisition (if applicable), problem-solving, and numeracy. Another objective met by these methods is to assist adolescent parents acquiring necessary credits in all core subjects that will enable them to receive a secondary school diploma or a high school equivalency certificate (also referred to herein as “GED”). Another objective met is to prepare certain adolescent parents for gaining entry into postsecondary education or entry into the military. Yet another objective is that certain adolescent parents will achieve pre-defined goals for job placement and earn certification in work readiness, or at least qualification therefor. A further objective accomplished by these methods is to assist adolescent parents in developing and increasing their parental skills and abilities, acquiring strategies for becoming effective models of literacy and life skills for their young children. For example, they may recognize and assume the role of their young child's first teacher so that their children will benefit from parents who give their children a solid foundation for learning, encouraging their child's literacy. Another objective may be that residential students develop the necessary skills to succeed in group living, assuming responsibilities as appropriate for daily living. For example, the use of literacy acquisition as a context to address critical social problems in their lives and to foster economic stability for the family are goals illustrative of this objective. It is appreciated that other objectives as are apparent by those having ordinary skill in the art may be realized by the practice of the various methods, taken individually or in combination, and are thus within the spirit of the invention and described with reference to example embodiments as illustrated in the figures presented.

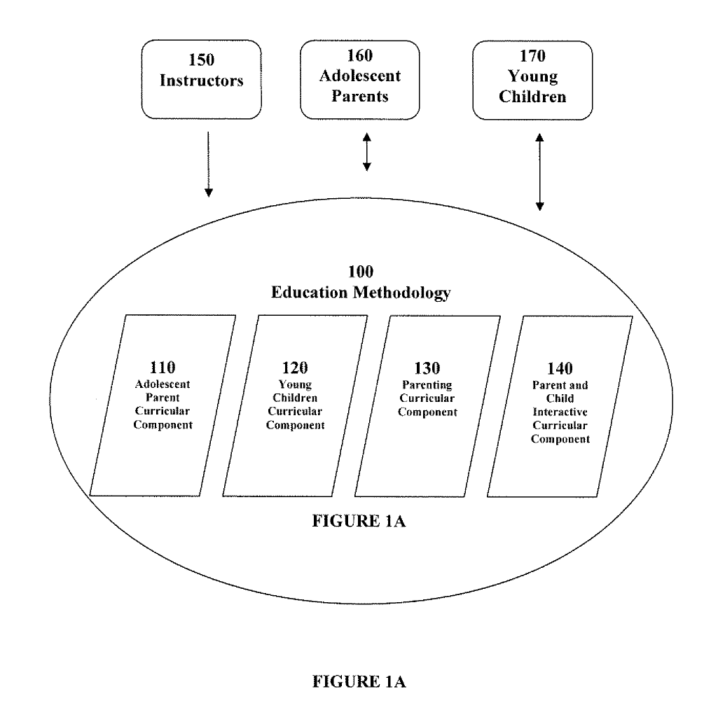

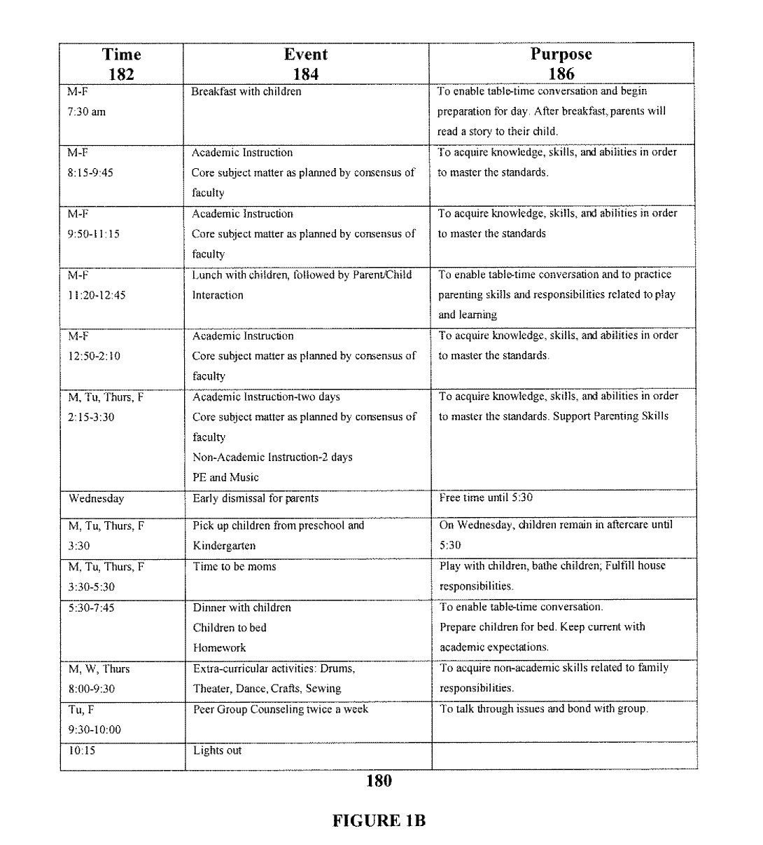

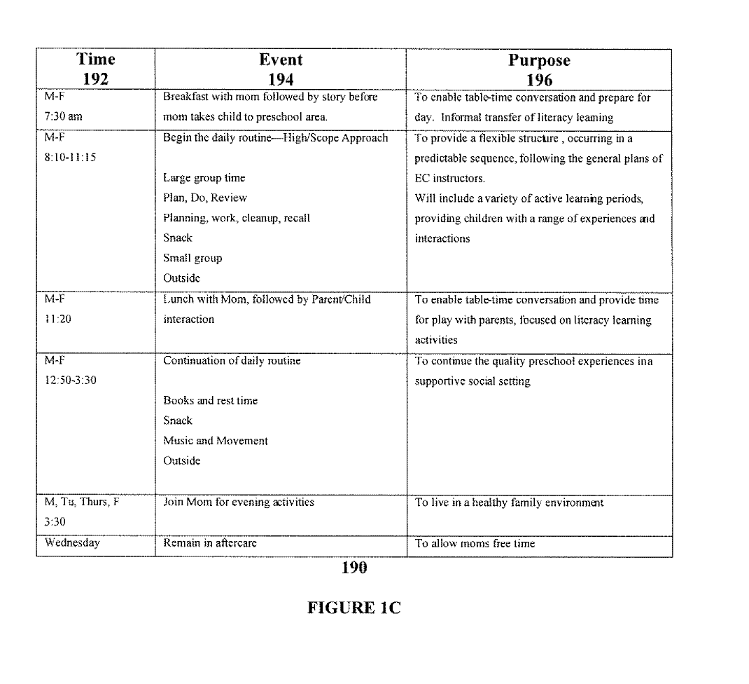

With reference to FIG. 1A, an embodiment of the present invention includes the unique combination of curricular components that, as a whole, creates an education methodology 100 specifically tailored to more effectively educate adolescent parents 160 and their young children 170 through a unique learning environment as partially led by instructors 150 and partially by the student body, including the adolescent parents 160. More specifically, the curricular components may include an adolescent parent curricular component 110, a young children curricular component 120, a parenting curricular component 130, and a parent and child interactive component 140.

The education methodology 100 is flexibly developed using a creative, “problem-based” approach, which ultimately manifests as a “project-based” curriculum. A “problem” is defined as an investigation involving a wide-range of activities with the most critical characteristics being that the activities comprise some whole task rather than only components of a task and that the task is representative of those the student will encounter in the real world following instruction. Therefore, the “problem” is also known as “learner goals.” These learner goals are the critical issues in their lives. The curriculum development process is participatory and is based on a collaborative investigation of critical issues in family and community life. Thus it becomes project-based. In one example embodiment of designing the education methodology 100, instructors and students collaboratively plan and practice the principles of instruction, incorporating individualized, small group, and large-group instruction within the methodology and each curriculum component.

The curriculum developed in a project-based approach may be broken down into activation, application, and integration steps. Example activation steps may include: identify the problem or goal for instruction and the possible standards that will help students achieve the goals; identify the shared interest, the problem, and/or the student goal, and focus on an objective and/or standard that will help the group address this shared problem/goal; design an activity to address the real-life concerns of the students (i.e., the identified problem); and develop a plan to capture, evidence, and report learning objectives. Example application steps may include: carrying out the learning activity, observing the activity; and documenting evidence of meeting the objectives and standards. Example integration steps may include: evaluating and reflecting on how what was learned is transferable to real-life situations; determining next steps to help students meet their goals; and assisting students to understand how the solving the “problem” is representative of those that the student will encounter in the world following instruction.

It is appreciated that the curriculum, the objectives, and the students' performance during the practice of the education methodology 100 may be observed, critiqued, and improved over time. The education methodology 100 may be used in conjunction with a variety of assessments means, some of which may be considered “traditional,” but most of which may be described as “student-centered” means. To correlate with the example approach to active project-based learning/problem-solving curriculum, as described above, the methodology 100 may include assessment tasks, in which students are called upon to access prior knowledge and accumulated skills and apply to novel situations. Such tasks, applied in public forum, may include essay writing, grocery shopping and cooking, map-making and travel, problem-framing and problem-solving, public speaking, dramatic presentations, and other problem-solving with math, science, and social studies, and the like. The methodology 100 may integrate those activities by identifying learning gains, and by reflecting on group and individual learning processes. To assist with the assessment of performance, portfolio collections and maintenance may be required for the students, including those practicing the adolescent parent curricular component 110 and the young children curricular component 120. Students and instructors may work together to identify what performance indicators work best and which indicate growth and progress.

Furthermore, the students' performance may be measured against certain objectives and standards as a means for identifying students who qualify for promotion through the curriculum or for graduation from the curriculum. Certain performance indicators for adolescent parent students 160 may include: GED or high school diploma standards developed either internally or by the local municipality or state determined standards, standardized tests as accepted in the art, and through specific subject matter tests that align with certain curriculum sub-components and objectives.

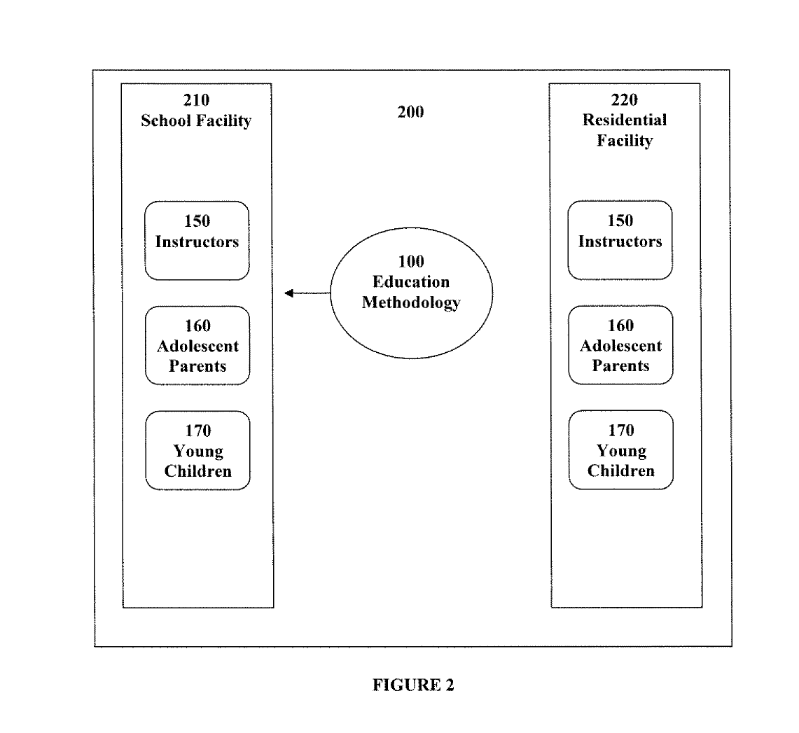

FIG. 1B illustrates one example of a weekly schedule 180 as may be utilized to practice an embodiment of the present invention. It is appreciated that the times indicated in the time column 182 are merely exemplary and can be adjusted based on factors such as the composition of the student body, instructor schedules, local school system schedules, adolescent parent work schedules, and the like, as is appreciated in the art. The event column 184 illustrates example activities to implement the below-discussed curricular components, and to achieve the goals and purposes as discussed below and illustrated by example in the purpose column 186. It is appreciated that this schedule and the events and/or purposes illustrated in FIG. 1B are merely exemplary and may be substituted with one or more combinations of the components, sub-components, themes, activities, objectives, and goals, as are discussed in more detail with reference to FIG. 1A and 2.

In one embodiment, the education methodology 100 may be a year-round school, with a continuation of the academic year into a summer program. During this extended period, students will participate in remediation or acceleration studies, as well as targeted extra-curricular activities. Because most of our students may participate in a boarding component, as is more fully described in reference to FIG. 2, the school day may be organized and structured to maximize benefits to both the adolescent parents 160 and their young children 170. However, it is appreciated that students not participating in the optional boarding component may follow at least some components of the same or similar academic plan.

Adolescent Parent Curricular Component

The adolescent parent curricular component 110, as illustrated in FIG. 1A, is specifically designed to adapt to the unique learning styles of adolescent parents 160. Specifically, it is intended to provide a fundamental education to students ranging in age from approximately fourteen to twenty-one years old, for example, that are parents of young children. The adolescent parent curricular component 110 may be adapted, at least in part, from the Equipped for the Future Standards (EFF), as developed by the National Institute for Literacy, and from the Expeditionary Learning, as developed by Outward Bound USA. The adolescent parent curricular component 110 modifies the EFF and Expeditionary Learning methodologies, providing progressive teaching—those that are student-centered, hands-on, project-based, and cooperative in nature.

Skills to be acquired via an adolescent parent's 160 participation in the adolescent parent curricular component 110 may include communication skills, decision-making skills, interpersonal skills, and lifelong learning skills. More specifically, certain skills and standards against which the students participating in the adolescent parent curricular component 110 may be assessed may include: acquiring, using, and sharing information accurately and in a timely manner; using appropriate technology to get the job done; understanding systems and technology with sufficient proficiency; monitoring and correcting their own (and/or others') performance; understanding the world in spatial and political terms (e.g., taking into consideration other geographical, political, and cultural factors from around the world); understanding the importance of historical influence; conveying ideas in art; understanding the importance, function, and effectiveness of utilizing music; working as part of a team to achieve goals and objectives; working through conflict constructively; providing direct, accurate, and timely responses to questions and concerns from others, professionally, academically, and socially; taking responsibility for completing one's own work accurately, on time, and to a high standard of quality; demonstrating integrity; avoiding absenteeism; demonstrating promptness; maintaining appropriate grooming and hygiene; managing time effectively; creating a vision; working within a holistic view of a given activity; working together with others; exhibiting leadership qualities; coping with a work situation or tasks that change frequently; identifying actual or potential problems related to one's work and reporting the problems to achieve resolution; learning new and/or additional skills related to one's job; developing and expressing a sense of self; valuing diversity; pursuing goals; advocating and influencing a position; resolving conflict; and negotiating effectively.

Specific sub-components of the adolescent parent curricular component 110 may in some embodiments include language development, vocabulary and concept development, writing development, and understanding and usage of common media. More specifically, the language development sub-component may further include the concepts of effective speaking, active listening, and reading comprehension. The writing development sub-component may include the concepts of determining purpose in writing, attributing the proper context, purpose, and audience, learning conventional language usage skills, and adopting effective writing practices such as feedback and revision. The media sub-component may include the concepts of utilizing various media as sources for information and presentation, adjusting comprehension strategies unique to media type, analyzing and attributing accuracies, inaccuracies, biases, and source-related distortion. Furthermore, one or more of the above-discussed sub-components may be demonstrated through community volunteering experiences.

The adolescent parent curricular component 110 may be delivered using one or more common themes to achieve the above-discussed objectives, goals, and standards. Some example themes may include instructing the students on understanding appropriate sources for information and obtaining access so as to promote self-education, educate students to cultivate their own voice for self-expression and productive communication, promote independent thinking and action to learn independence and self-reliance, understand the future and keeping up with social, political, economic, and/or technological changes.

Certain adolescent parents 160 participating in the education methodology 100 may have unique needs that are best addressed by certain sub-components of the adolescent parent curricular component 110. Additionally, these unique needs may add further skills and qualities taught through the adolescent parent curricular component 110. For example, the methodology 100 may additionally cater to limited English proficient students through programs, such as English as a secondary language, that include a tailored focus of vocabulary, syntactic, phonological, and schema activation sub-components. In another example, the methodology 100 may be additionally be tailored to students with learning disabilities and special education needs. The education methodology 100 may include an identification stage that considers indicators for learning disabled students, as are known in the art. More specifically, the methodology 100 may include an evaluation stage, a diagnosis stage, and a recommendation stage. The evaluation stage may include screening, review by professionals, and team review. The diagnosis stage may include an explanation of the disabilities and determination of eligibility for the needs. The recommendations stage may include recommendations from the professionals and recommendations by the school as to appropriate sub-components and accommodations.

The adolescent parent curricular component 110 may additionally include a summer orientation session that will provide the adolescent parent students 160 with strategies and skills for learning. Specific skills provided in the summer orientation session may include, but not be limited to: how to learn; how to use a dictionary and other print learning tools; the basics of grammar and language skills; basic strategies for studying; effective use of available technologies; and study skills for improving life management concepts. Additionally, the adolescent curricular component 110 may further include follow-up summer sessions designed to remediate or to accelerate learning.

The performance of the adolescent parent students 160 will be monitored against accepted performance standards. Some benefits of the adolescent parent curricular component 110 are that the curriculum differs from traditional adult education and secondary education curricula in that it targets the needs, interests, and goals of teen parents. Furthermore, utilizing accepted performance standards also fosters fundamental academic achievement in areas such as reading, writing, mathematics, problem solving, communication social studies, and the sciences.

Performance standards against which the adolescent parent students 160 may be judged may be implemented using one or more of these multiple techniques and/or practices, discussed. Instruction may be constantly monitored and adjusted to meet varied student needs. Students may be able to monitor their own learning and adjust their own strategies to redirect their learning activities. Assessment may reflect a fuller profile of student progress by including qualitative and quantitative information, and assessment information may be used to adjust the curriculum and the instruction. The curriculum and the instruction may be a means to help the student achieve the standards, with a focus on the student. Professional development activities may be identified systematically to help instructors enable students to achieve standards. Public engagement may occur in a continuous conversation among the parents, the community, and the school. Achievement may be seen as complex factors, irreducible to individual facts/skills, influenced by experience and opportunities. Students may be privy to what they will be examined on and knowledgeable about the criteria for judging their work. Students may work independently or in groups, depending on the task and student needs. Finally, the students may be expected to achieve in some or all of the above-discussed standards, but in different ways and at different rates.

Young Children Curricular Component

The young children curricular component 120, as illustrated in FIG. 1A, is specifically designed to provide a healthy learning environment for young children 170 of adolescent parents 160 that may range from approximately three to five years old, for example. The young children curricular component 120 may be modeled, at least in part, on the Active Learning Practices for Preschool and Child Care Programs, as developed by High Scope Educational Research Foundation. Some benefits of the component may be that it creates an active learning environment that support the young children's 170 needs for engagement and learning.

Objectives of the young children curricular component 120 may include, but not be limited to: promoting language and literacy learning; promoting social development; promoting emotional development; and providing for physical needs. These objectives may be achieved through the implementation of the young children curricular component 120 utilizing an active learning approach. The approach may carefully center the acquisition of knowledge in a framework that may further include a constructivist approach, a supportive climate, family involvement, and adult collaboration. The design of the instruction may especially coincide with the facilities physical design, as is further described with reference to FIG. 2. In other words, the classroom may be arranged to provide a literacy center that may include areas for oral language development, early print awareness, math manipulation, science and social studies experiments, and art and music experiences, all surrounded by the focus on language arts. Furthermore, an active learning environment may bring together settings, spaces, and daily routines that support the young children's 170 engagement and learning.

The daily routine of the young children curricular component 120 may include individual interest times, group times, outside times, and transition times, during which the curriculum focuses on certain sub-components and certain goals for each of these development objectives. Small group time, for example, may be reserved for children to experiment with materials, to pursue an expressed interest, and to solve problems. Large group time builds a sense of community for children, as they come together, for example, for singing, movement and music activities, story telling, and play demonstrations. Outside time is designed for vigorous, physical play, at least 30-40 minutes twice a day, for example.

In one example, a process may include a “plan-do-review” philosophy, whereby the work time is constructivist in nature and supported by adults to encourage problem-solving. The plan-do-review philosophy may also be referred to as the “plan-work-recall” approach. In one example embodiment of the education methodology 100, the young children curricular component 120 may include plan-do-review that comprises the longest and most intense block of the day. It is designed to build upon and strengthen children's natural interests, capacity for initiative, and problem-solving skills.

Specific sub-components of the young children curricular component 120 may in some embodiments include activities directed toward early development of: creative representation; language and literacy; initiative and social relations; movement; music; classification; seriation; number and math concepts; space; and time.

FIG. 1C illustrates another example of a weekly schedule 190, with particular focus on the activities that are directed toward the young children curricular component 120. Similar to FIG. 1B, described above, the young children weekly schedule 190 includes an example time column 192, an example events column 194, and an example purposes column 196, each illustrating an example weekly schedule 190 implementing an embodiment of the young children curricular component 120.

Parenting Curricular Component

The parenting curricular component 130 is specifically designed to increase adolescent parent students' 160 parenting skills and allow the adolescent parents 160 to become positive models of literacy, life, and family for their young children 170. The parenting curricular component 130 may be modeled, at least in part, on the Born to Learn and Meld methodologies, as developed by Parents as Teachers National Center. Some benefits the adolescent parents 160 may realize are, among others, learning parenting and life skills that will foster them becoming effective family leaders and learning good judgment for their future success and the success of their young children 170.

The parenting curricular component 130 is designed to strengthen their children's literacy development and school-related competence. Some objectives that may be achieved by this parenting curricular component 130 are: promoting language-rich parent/child interactions; encouraging the parent's role in the children's educational development; supporting literacy in the family unit; setting appropriate expectations of the child's learning and development; embracing the parenting role; strengthening the family relationship with the community; understanding and meeting family needs and responsibilities; strengthening a close family system; encouraging the exercise of sound judgment and positive behavior as parents; planning for and achieving professional growth; and forming and maintaining connections with the community and other resources.

This parenting curricular component 130 is one that has parent involvement built into the structure, from parenting classes, to its integration with the below discussed parent and child interaction curricular component 140, to the day-to-day interface between what the adolescent parents and children are learning, to the after-school activities. Finally, parents may have the opportunity for involvement through the governance design that includes a parent council with representatives for the upper and lower school divisions; the advisory board, and the student leadership forum.

Parent and Child Interactive Component

Closely related to the parenting curricular component 130 is the parent and child interactive curricular component 140 that is specifically designed to educate the adolescent parents 160 on actively participating in the development of their young children adolescent parent curricular component 170. The parent and child interactive curricular component 140 may also be modeled, at least in part, on the Born to Learn and Meld methodologies, as developed by Parents as Teachers National Center. Specifically, adolescent parents 160 may participate in their young children's 170 curriculum through daily classroom interface and after-school activities, and may also actively participate in the governance of the curricula. Some benefits achieved by the parent and child interactive curricular component 140 are fostering the communication and the sharing between the adolescent parents 160 and their young children 170, including allowing the adolescent parents 160 to gain more understanding of the needs of their young children 170 and how to further educate their young children 170.

The parent and child interactive curricular component 140 is designed to serve as a laboratory for learning. It is both a physical space and a theoretical stance. In this period of the day the adolescent parent students 160 tend to their young children students 170 in a classroom setting, by playing, talking, reading, and singing, for example, as a way of becoming more involved in their children's learning. The parent and child interactive curricular component 140 is a purposeful design that encourages a crosswalk between the adolescent parent curricular component 110 and the young children curricular component 120, which teaches parents about early learning and its relationship to later learning and life skills. In one example embodiment, the adolescent parents 160 may conference on a regular basis with instructors 150 of the young children curricular component 120, providing and collecting information that will support their child's learning as it fits with the school accountability plan.

Boarding Component

With reference to FIG. 2, an embodiment of the present invention includes a boarding component 200, which is specifically designed to provide one or more residential facilities 220 in which adolescent parent students 160 and their young children students 170 may live. The residential facility 220 may include one or more private living facilities for each family and may also include one or more community spaces in close proximity to the one or more private living facilities (not shown). The living facilities and community spaces may be closely situated to the school facility 210 in which some or all of the above discussed curricular components of the education methodology 100 will take place. Student families participating having adolescent parents 160 and young children 170 in the boarding component 200 may participate in support groups, individual instruction, and mentoring. Student families having adolescent parents 160 and young children 170 not participating in the boarding component 200 may also participate in some or all of the programs offered to the student families participating in the boarding component 200. Some of the benefits that may be achieved by the boarding component 200 are promoting family growth and development, identifying and satisfying unmet needs of student families, and strengthening the family bonds. Other benefits that may be achieved by this component are the increased socialization between peer groups—both adolescent parents 160 and young children 170—and learning life skills such as cooking and cleaning. Additionally, having some or all of the student families residing under the control of the instructors 150 of the program promotes watchfulness by the instructors 150, allowing them to address needs and encourage persistence by the adolescent parents 160 and young children 170 in applying the goals of the education methodology 100.

The physical space the residential facility 220 may be organized into clusters of living areas. Each living area may include a large common area, a kitchen, and several private residential apartments. The residential facility 220 may be organized almost as an early childhood “dramatic play” area for the adolescent parents 160. This design encourages learning life skills (e.g., cooking, cleaning, sewing, communication, and the like) and social skills (e.g., conversation, play with others, empathy, individualism, sharing, and the like). These are the lessons that experience and research indicates are missing in our adolescent parents. Each boarding cluster may non-boarding students who participate in parent education, support groups, and life skills classes along with them.

Instructors 150, some of whom may also reside on in the residential facility 220, are assigned to work with families in each of the living areas. These instructors 150 may further be supervised by one or more superior instructors 150 or management/administrative personnel. Instructors 150 participating boarding in the component 200 may be trained to promote healthy living patterns within and among student families. For example, the instructors 150 may be trained to use intervention methodologies that can be applied to reduce potential conflicts, while modeling positive behaviors. So, if for example, after a day of classes, a tired adolescent parent student 160 yells at her child, an instructor 150 intervene by encouraging the adolescent parent student 160 to reflect on her own behavior, to examine the realities, and to demonstrate the more appropriate communication techniques. The instructors 150 may also be responsible for leading activities that promote reading literacy and family literacy skills for adolescent parent students 160 and young children students 170. In some embodiments, the instructors 150 may also directly teach the adolescent parent students 160 certain skills and sub-components of the adolescent parent curricular component 110, the parenting curricular component 130, and/or the parent and children interaction component 140, as is appropriate in the boarding component 200 setting. For example, some of these activities may promote life skills (e.g., cooking, cleaning, and the like) and model social skills (e.g., conversation, play with others, sharing, and the like).

Although the above description discloses one embodiment, that embodiment is exemplary only, and one skilled in the art will understand that other embodiments and variations may be possible and within the purview of this invention.

That which is claimed:

1. An method of educating comprising:
instructing a plurality of adolescent parents, wherein the instruction given is specifically adapted to the needs of the plurality of adolescent parents, and wherein at least a portion of the instruction given teaches parenting skills and life skills;
instructing at least one young child of each of the plurality of adolescent parents, wherein at least a portion of the instruction is given by the plurality of adolescent parents to the at least one young child; and
residing in at least one residential facility by the plurality of adolescent parents and the at least one young child of each of the plurality of adolescent parents.

2. The method of educating in claim 1, wherein instructing the plurality of adolescent parents comprises progressive learning.

3. The method of educating in claim 1, further comprising assessing the performance of the plurality of adolescent parents by an accepted performance standard.

4. The method of educating in claim 1, wherein the plurality of adolescent parents are each between fourteen and twenty-one years of age.

5. The method of educating in claim 1, wherein the at least one residential facility comprises a plurality of private residence spaces.

6. The method of educating in claim 1, wherein the at least one residential facility comprises at least one communal space.

7. The method of educating in claim 6, wherein the at least one communal space include a kitchen.

8. The method of educating in claim 1, wherein the instructing the plurality of adolescent parents and the instructing at least one young child of each of the plurality of adolescent parents comprises instructing in the at least one residential facility.

9. The method of educating in claim 1, further comprising interactive instruction from the plurality of adolescent parents to the at least one young child.

10. A method of educating, comprising:
instructing a plurality of adolescent parents by at least one instructor;
instructing at least one young child of each of the plurality of adolescent parents by the at least one instructor;
instructing the at least one young child of each of the plurality of adolescent parents by the plurality of adolescent parents; and
residing in at least one residential facility by the plurality of adolescent parents and the at least one young child of each of the plurality of adolescent parents.

11. The method of claim 10, wherein the adolescent parents instruct their own children.

12. The method of claim 10, further comprising residing in the at least one residential facility by the at least one instructor.
